(19) United States
(12) Patent Application Publication
(10) Pub. No.: US 2026/0110584 A1
(43) Pub. Date: Apr. 23, 2026

(54) METHOD FOR PREPARING CARBON MICROPARTICLE COMPOSITE MATERIAL, FLEXIBLE ELECTRODE MATERIAL, AND METHOD FOR PREPARING FLEXIBLE ELECTRODE

(71) Applicant: Chongqing University, Chongqing (CN)

(72) Inventors: Xiaoping ZHOU, Chongqing (CN); Zheng LUO, Chongqing (CN); Zheyu YANG, Chongqing (CN); Hao BAI, Chengdu (CN)

(21) Appl. No.: 19/361,055

(22) Filed: Oct. 17, 2025

(30) Foreign Application Priority Data
Oct. 17, 2024 (CN) 202411449978.6

(51) Int. Cl. G01L 1/22; C01B 32/17; C01B 32/196; C09D 11/037; C09D 11/52

(52) U.S. Cl. CPC G01L 1/2287; C01B 32/17; C01B 32/196; C09D 11/037; C09D 11/52; C01B 2202/06; C01B 2202/22; C01B 2204/22; C01P 2002/72; C01P 2004/02; C01P 2004/133; C01P 2004/80; C01P 2006/40

(57) ABSTRACT

The disclosure provides a flexible electrode material, a flexible electrode, and their preparation methods and applications, belonging to the technical field of composite materials. The carbon microparticle composite material includes carbon particles and gallium oxide attached to the surface of the carbon microparticles. The flexible electrode material includes, by mass, 2-17 parts of gallium-coated carbon particles and 83-98 parts of liquid metal. The flexible electrode is prepared by coating the flexible electrode material onto a flexible substrate via screen printing, attaching copper conductive wires to both ends of the printed flexible electrode material, applying a viscoelastic material coating over the surface of the flexible electrode material, and curing and drying the flexible electrode material at room temperature. The composite material can be applied to electronic skin for detecting human body motion states and earth pressure cells for monitoring soil pressure in engineering projects.

### CROSS-REFERENCE TO RELATED APPLICATIONS

Pursuant to 35 U.S.C. § 119 and the Paris Convention Treaty, this application claims foreign priority to Chinese Patent Application No. 202411449978.6 filed Oct. 17, 2024, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to a method for preparing a carbon microparticle composite material, a flexible electrode material, a method for preparing a flexible electrode, and its use as sensitive elements for flexible electronic skin and earth pressure cells.

Flexible electrodes serve as a crucial sensing technology to achieve precise and rapid perception of the external environment, with application domains spanning artificial intelligent skin, biomedicine, bionic flexible actuators, flexible electronics, robotics, engineering monitoring, and many other fields.

Currently, gallium-based liquid metals are widely employed in the manufacturing of flexible electrodes due to their high electrical conductivity, self-healing capability, non-toxicity, and unique surface chemical properties. However, liquid metals possess extremely high interfacial tension, which results in high fluidity. Furthermore, under ambient conditions, a unique metal oxide layer naturally forms on the surface of liquid metals.

To address the aforementioned challenges, conventional methods for modifying gallium-based liquid metals and preparing liquid metal pastes involve uniformly dispersing magnetic metal powder into the liquid metal within an inert gas atmosphere to produce a ready-to-use paste. Although the inert gas atmosphere prevents the formation of the oxide layer on the liquid metal and facilitates the incorporation of the metal powder, the liquid metal within the resulting paste tends to corrode the metal powder. This corrosion adversely affects the electrical conductivity, thermal conductivity, and magnetic response performance of the liquid metal paste. Additionally, a conventional method is to coat FeNbVB particles with a layer of SiO2, which exhibits high compatibility with the liquid metal, thus promoting the uniform mixing of FeNbVB with the liquid metal in a normal atmospheric environment. However, due to the insulating nature of SiO₂, this method significantly reduces the electrical conductivity of the resultant liquid metal paste. Consequently, pastes prepared by this method fail to meet the high conductivity requirements essential for flexible electrode materials.

### SUMMARY

To solve the problem of corrosion of conventional conductive materials in liquid metal environments, in one aspect, the disclosure provides a carbon microparticle composite material that overcomes the compatibility challenges between carbon microparticles and liquid metal while resisting corrosion by the liquid metal. In another aspect, the disclosure provides a flexible electrode material comprising the composite material, exhibiting flexibility, fast response time, high sensitivity, and excellent stability. Additionally, the disclosure also provides methods for preparing the carbon microparticle composite material, flexible electrodes incorporating the same, methods for manufacturing such flexible electrodes, and various applications thereof.

In one aspect, the disclosure provides a gallium oxide-carbon microparticle composite material comprising carbon microparticles and gallium oxide attached to surfaces of the carbon microparticles; the carbon microparticles are carbon nanotubes or graphene.

In another aspect, the disclosure provides a method for preparing a carbon microparticle composite material, comprising:
1) purifying carbon microparticles by: i) mixing the carbon microparticles with an acidic solution to form a mixture; ii) heating the mixture using an oil bath under water reflux at room temperature in a condenser to obtain purified carbon microparticles, wherein the purified carbon microparticles have reduced impurity content and are dispersed, and the carbon microparticles are selected from the group consisting of multi-walled carbon nanotubes (MWCNTs) and graphene; and
2) compositing gallium oxide on surfaces of the purified carbon microparticles by: i) combining the purified carbon microparticles with gallium chloride in ultrapure water to form a reaction precursor; ii) transferring the reaction precursor to a reaction autoclave for a hydrothermal reaction to obtain a gallium oxide-carbon microparticle composite; and iii) calcining the gallium oxide-carbon microparticle composite in a tube furnace under a nitrogen atmosphere to yield a gallium oxide-carbon microparticle composite material with increased crystallinity.

In a class of this embodiment, the acidic solution in 1) is nitric acid or hydrochloric acid having a concentration of H from about 1M to about 3M.

In a third aspect, the disclosure further provides a flexible electrode material, comprising a mixture of 2-17 parts by mass of the gallium oxide-carbon microparticle composite material and 83-98 parts by mass of a liquid metal, and the liquid metal is a gallium-indium alloy or a gallium-indium-tin alloy.

In a fourth aspect, the disclosure also provides a method for preparing a flexible electrode, comprising: coating the flexible electrode material onto a flexible substrate via screen printing, attaching conductive wires to both ends of the flexible electrode material, applying a viscoelastic material coating over a surface of the flexible electrode material, and curing and drying the flexible electrode material at room temperature to obtain the flexible electrode.

In a fifth aspect, the disclosure provides a method for preparing a flexible single-electrode, comprising:
Step A: preparing a liquid metal paste by mixing 2-17 parts by mass of a gallium oxide-carbon microparticle composite material with 83-98 parts by mass of a liquid metal;
Step B: forming a flexible electrode by coating the liquid metal paste onto a surface of a flexible substrate via screen printing; and
Step C: producing a single-electrode by attaching conductive wires to terminal portions of the liquid metal paste, applying a viscoelastic material over the surface of the liquid metal paste, and drying at room temperature to obtain an encapsulated single-electrode.

In a sixth aspect, the flexible electrode described above is used as an electronic skin for detecting human motion states.

In a seventh aspect, the flexible electrode described above functions as a sensing element in an earth pressure cell for measuring soil pressure.

In an eighth aspect, the disclosure provides an earth pressure cell, comprising: a cylindrical housing; and a connection cylinder, a spacer, a flexible electrode, and a bottom cover, which are disposed in sequence from top to bottom within a cavity of the cylindrical housing; the connection cylinder is disposed at a central portion between an inner bottom surface of the cylindrical housing and the spacer; the spacer, the flexible electrode, and the bottom cover are in surface contact with each other; and a conductive lead of the flexible electrode extends outwardly from the cavity of the cylindrical housing.

The following advantages are associated with the method for preparing a carbon microparticle composite material, a flexible electrode material, and a method for preparing a flexible electrode of the disclosure.

The flexible electrode material of the disclosure incorporates a gallium-containing carbon microparticle composite material into liquid metal, thereby overcoming the compatibility challenges between carbon microparticles and liquid metal while preventing corrosion of the conductive metal additives by the liquid metal.

The flexible electrode material of the disclosure, formulated as a liquid metal paste, not only enables direct patterning of the liquid metal but also maintains the high electrical conductivity required for electrode applications. When the liquid metal paste of the disclosure is used to fabricate flexible electrodes for electronic skin capable of detecting human motion states and earth pressure cells for monitoring soil pressure in engineering applications, it satisfies key requirements including a streamlined manufacturing process, fast response times, high sensitivity, and superior stability.

### BRIEF DESCRIPTION OF THE DRAWINGS

FIGS. 1A-1B show micro-morphology images of purified carbon nanotubes prepared according to Example 1.

FIGS. 2A-2F show micro-morphology and elemental energy spectrum images of a gallium oxide-carbon nanotube composite material prepared according to Example 1; FIGS. 2A and 2B show micro-morphology images of the gallium oxide-carbon nanotube composite material; FIGS. 2C-2F show elemental energy spectrum images of the gallium oxide-carbon nanotube composite material.

FIG. 3 shows an X-ray diffraction pattern of purified carbon nanotubes and the gallium oxide-carbon nanotube composite material prepared according to Example 1.

FIG. 4 shows electrical conductivity curves of flexible electrodes comprising the gallium oxide-carbon nanotube composite material and a liquid metal at different content ratios, prepared according to Examples 1, 2, 3, 4, and 5.

FIGS. 5A-5B show micro-morphology images of purified graphene prepared according to Example 6.

FIGS. 6A-6F show micro-morphology and elemental energy spectrum images of a gallium oxide-graphene composite material prepared according to Example 6;

FIGS. 6A and 6B show micro-morphology images of the gallium oxide-graphene composite material;

FIGS. 6C-6F show elemental energy spectrum images of the gallium oxide-graphene composite material.

FIG. 7 shows an X-ray diffraction pattern of the gallium oxide-graphene composite material prepared according to Example 6.

FIG. 8 shows electrical conductivity curves of flexible electrodes comprising the gallium oxide-graphene composite material and a liquid metal at different content ratios, prepared according to Examples 6, 7, 8, 9, and 10.

FIG. 9 illustrates a preparation process of a flexible electrode of the disclosure, used as an electronic skin and an earth pressure cell sensing element.

FIGS. 10A-10D show the use of the flexible electrode of the disclosure as an electronic skin for detecting human joint movement;

FIG. 10A shows a resistance response curve for finger bending; FIG. 10B shows a resistance response curve for elbow joint bending; FIG. 10C shows a resistance response curve for knee joint bending;

FIG. 10D is a schematic diagram showing different parts of the human body wherein the flexible electrode is used as an electronic skin for motion detection.

FIGS. 11A-11F show the use of the flexible electrode material of the disclosure as a sensing element for an earth pressure cell to monitor soil pressure;

FIG. 11A is an exploded view of the earth pressure cell; FIG. 11B is a top view of the earth pressure cell; FIG. 11C is a front view of the earth pressure cell; FIG. 11D is a photograph of the earth pressure cell; FIG. 11E shows a test curve and a theoretical curve of the earth pressure cell; FIG. 11F shows a stability test curve of the earth pressure cell.

### DETAILED DESCRIPTION

To further illustrate the disclosure, embodiments detailing a carbon microparticle composite material, a flexible electrode material, and a method for preparing a flexible electrode are described below. It should be noted that the following embodiments are intended to describe and not to limit the disclosure.

### Example 1

A gallium oxide-carbon nanotube composite material comprises carbon nanotubes and gallium oxide, with gallium oxide attached to the surface of the carbon nanotubes.

The preparation of the gallium oxide-carbon nanotube composite material is summarized as follows (by mass):
1. Purification of Carbon Nanotubes (MWCNTs): 2 parts of carbon nanotubes were purified in 100 parts of a 3M hydrochloric acid solution using an oil bath heater equipped with a condenser providing water reflux at room temperature, thereby eliminating impurities and dispersing the carbon nanotubes.

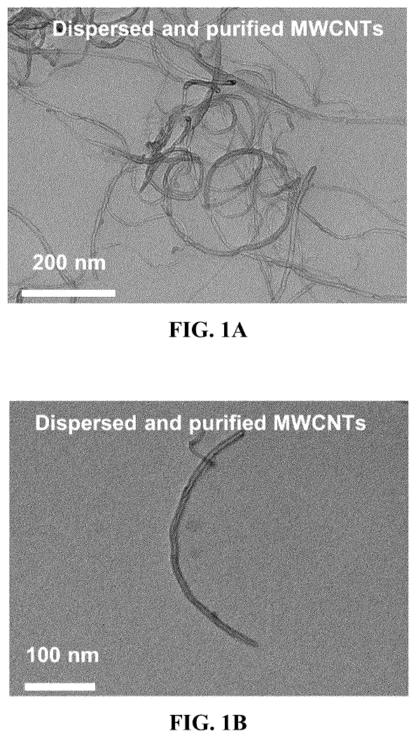

The microscopic morphology of the purified carbon nanotubes is shown in FIGS. 1A-1B. The purified carbon nanotubes exhibited reduced agglomeration and were well dispersed.
2. Formation of gallium oxide on carbon nanotube surfaces: 2 parts of the purified carbon nanotubes and 2 parts of gallium chloride were added to 20 parts of ultrapure water. The mixture was transferred to a hydrothermal reactor and subjected to a hydrothermal reaction at 180° C. for 10 hours, resulting in a gallium oxide-carbon nanotube composite material. This composite was subsequently calcined in a tube furnace at 600° C. for 2 hours under a nitrogen atmosphere to obtain a gallium oxide-carbon nanotube composite material with higher crystallinity.

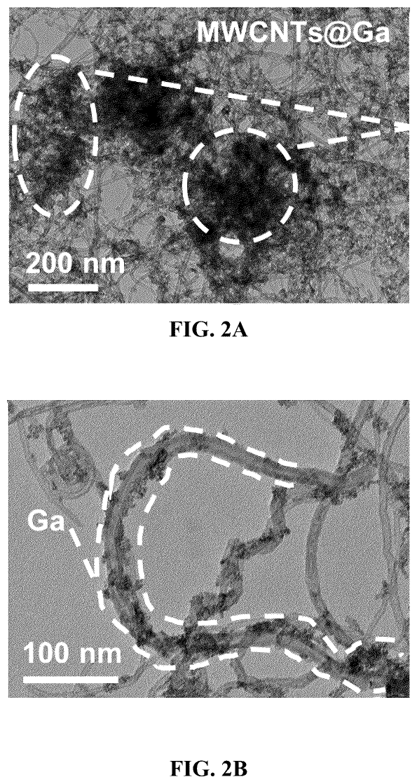

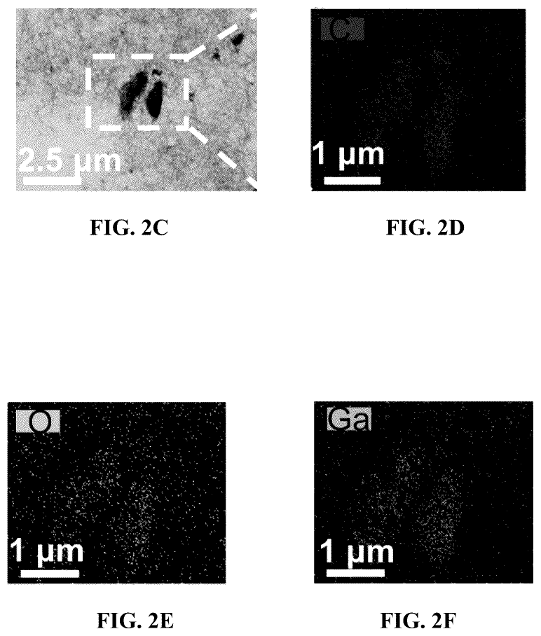

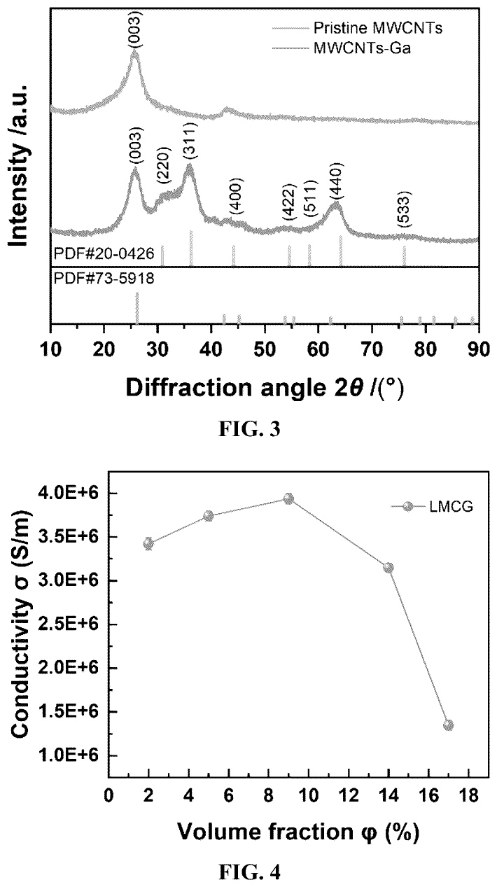

The microscopic morphology and elemental mapping of the gallium oxide-carbon nanotube composite material are described in FIGS. 2A-2F. As can be seen from FIGS. 2A and 2B, a layer of substance is attached to the surface of the carbon nanotubes. Furthermore, the Energy Dispersive Spectroscopy (EDS) characterization in FIGS. 2C-2F confirms the presence of O and Ga elements in this substance. FIG. 3 shows the X-ray diffraction (XRD) patterns of the purified carbon nanotubes and the gallium oxide-carbon nanotube composite material. The analysis conducted using the X-ray diffractometer demonstrates that this substance is gallium oxide.

The flexible electrode material of this example comprises a mixture of 2 parts of the gallium oxide-carbon nanotube composite material and 98 parts of a liquid metal, by mass. The liquid metal is a gallium-indium alloy or a gallium-indium-tin alloy.

The flexible electrode of this example is fabricated as follows: the flexible electrode material is coated onto a flexible substrate via screen printing. Copper wires are attached to two ends of the printed flexible electrode material. A viscoelastic material coating is then applied over the surface of the flexible electrode material. The assembly is cured and dried at room temperature to obtain the flexible electrode.

The flexible electrode material serves as a sensing element of the flexible electrode.

The preparation method of the flexible electrode in this example is as follows:
Step A. Preparation of Liquid Metal Paste: A liquid metal paste, which is the flexible electrode material, was obtained by mixing 2 parts of the gallium oxide-carbon nanotube composite material with 98 parts of liquid metal.
Step B. Preparation of Flexible Electrode: The liquid metal paste was coated onto the surface of an Ecoflex 00-30 flexible substrate via screen printing, resulting in the flexible electrode.
Step C. Fabrication of Single Electrode: A copper wire with a diameter of 0.05 mm was attached to the terminal end of the liquid metal paste. A silicone coating was then applied over the surface of the liquid metal paste. The assembly was dried at room temperature to obtain the encapsulated single electrode.

Electrical Conductivity Test: The resistance of the flexible electrode was measured using an LCR digital bridge tester, which has a resistance measurement range from 0 to 99.99 MΩ. To evaluate the electrical conductivity of the electrode, the conductivity was calculated using the following formula:

$$σ = L / ( S \times R ) ;$$

wherein σ represents the electrical conductivity, L represents a length of the electrode, S represents a cross-sectional area of the electrode, and R represents a measured resistance of the electrode.

The electrical conductivity test results for the flexible electrode of this example are shown in FIG. 4. The measured electrical conductivity of the flexible electrode was 3.42×10⁶ S/m.

### Example 2

Different from that in Example 1, the preparation method of the gallium oxide-carbon nanotube composite material in this example employed 100 parts by mass of a 2M hydrochloric acid solution, 5 parts of carbon nanotubes, 5 parts of gallium chloride, and 100 parts of ultrapure water.

The flexible electrode material of this example comprises a mixture of 5 parts of the gallium oxide-carbon nanotube composite material and 95 parts of liquid metal, by mass.

In Step A, the liquid metal paste was obtained by mixing 5 parts of the gallium oxide-carbon nanotube composite material with 95 parts of liquid metal.

The electrical conductivity test results for the flexible electrode of this example are shown in FIG. 4. The measured electrical conductivity of the flexible electrode was 3.74×10⁶ S/m.

### Example 3

Different from that in Example 1, the preparation method of the gallium oxide-carbon nanotube composite material in this example employed 100 parts by mass of a 3M nitric acid solution, 9 parts of carbon nanotubes, 9 parts of gallium chloride, and 100 parts of ultrapure water.

The flexible electrode material of this example comprises a mixture of 9 parts of the gallium oxide-carbon nanotube composite material and 91 parts of liquid metal, by mass.

In Step A, the liquid metal paste was obtained by mixing 9 parts of the gallium oxide-carbon nanotube composite material with 91 parts of liquid metal.

The electrical conductivity test results for the flexible electrode of this example are shown in FIG. 4. The measured electrical conductivity of the flexible electrode was 3.94×10⁶ S/m.

### Example 4

Different from that in Example 1, the preparation method of the gallium oxide-carbon nanotube composite material in this example employed 100 parts by mass of a 2M hydrochloric acid solution, 14 parts of carbon nanotubes, 14 parts of gallium chloride, and 100 parts of ultrapure water.

The flexible electrode material of this example comprises a mixture of 14 parts of the gallium oxide-carbon nanotube composite material and 86 parts of liquid metal, by mass.

In Step A, the liquid metal paste was obtained by mixing 14 parts of the gallium oxide-carbon nanotube composite material with 86 parts of liquid metal.

The electrical conductivity test results for the flexible electrode of this example are shown in FIG. 4. The measured electrical conductivity of the flexible electrode was 3.15×10⁶ S/m.

### Example 5

Different from that in Example 1, the preparation method of the gallium oxide-carbon nanotube composite material in this example employed 100 parts by mass of a 1M nitric acid solution, 17 parts of carbon nanotubes, 17 parts of gallium chloride, and 100 parts of ultrapure water.

The flexible electrode material of this example comprises a mixture of 17 parts of the gallium oxide-carbon nanotube composite material and 83 parts of liquid metal, by mass.

In Step A, the liquid metal paste was obtained by mixing 17 parts of the gallium oxide-carbon nanotube composite material with 83 parts of liquid metal.

The electrical conductivity test results for the flexible electrode of this example are shown in FIG. 4. The measured electrical conductivity of the flexible electrode was 1.35×10⁶ S/m.

### Example 6

A gallium oxide-graphene composite material comprises graphene and gallium oxide, with gallium oxide attached to the surface of the graphene.

The preparation of the gallium oxide-graphene composite material is summarized as follows (by mass):
1. Purification of Graphene: 2 parts of graphene were purified in 100 parts of a 3M hydrochloric acid solution using an oil bath heater equipped with a condenser providing water reflux at room temperature, thereby eliminating impurities and dispersing the graphene.

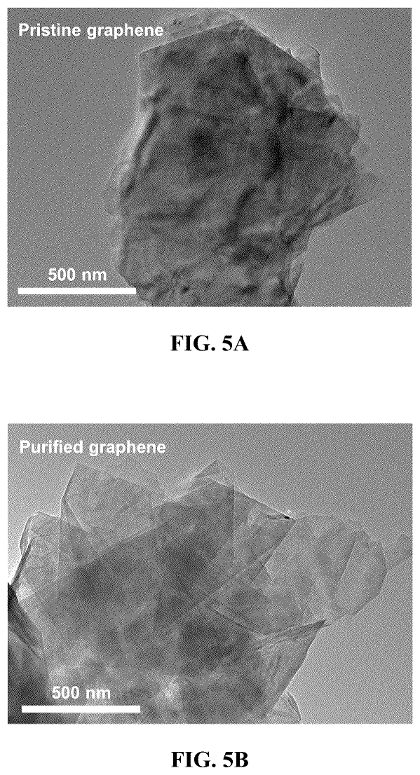

The microscopic morphology of the purified graphene is shown in FIGS. 5A-5B. The purified graphene exhibited a two-dimensional layered structure with slight interlayer wrinkling, showing layer separation and no longer adhering tightly together.
2. Formation of Gallium Oxide on Graphene Surfaces: 2 parts of the purified graphene and 2 parts of gallium chloride were added to 20 parts of ultrapure water. The mixture was transferred to a hydrothermal reactor and subjected to a hydrothermal reaction at 180° C. for 10 hours, resulting in a gallium oxide-graphene composite material. This composite was subsequently calcined in a tube furnace at 600° C. for 2 hours under a nitrogen atmosphere to obtain a gallium oxide-graphene composite material with higher crystallinity.

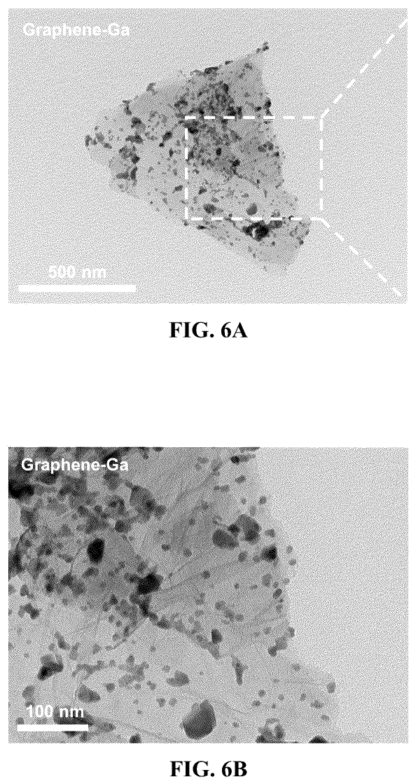

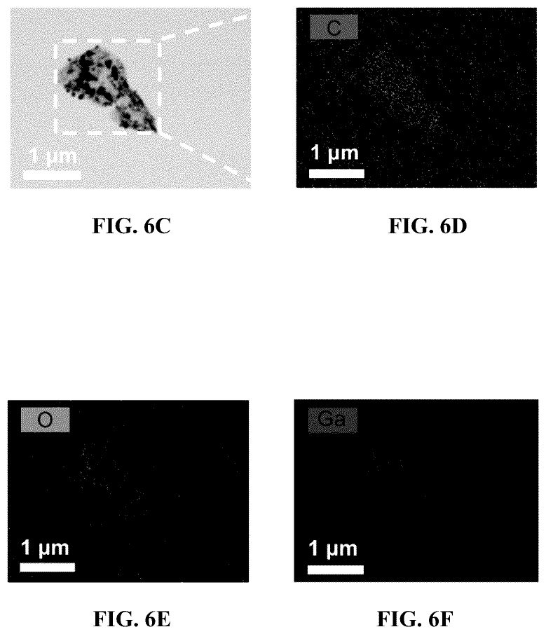

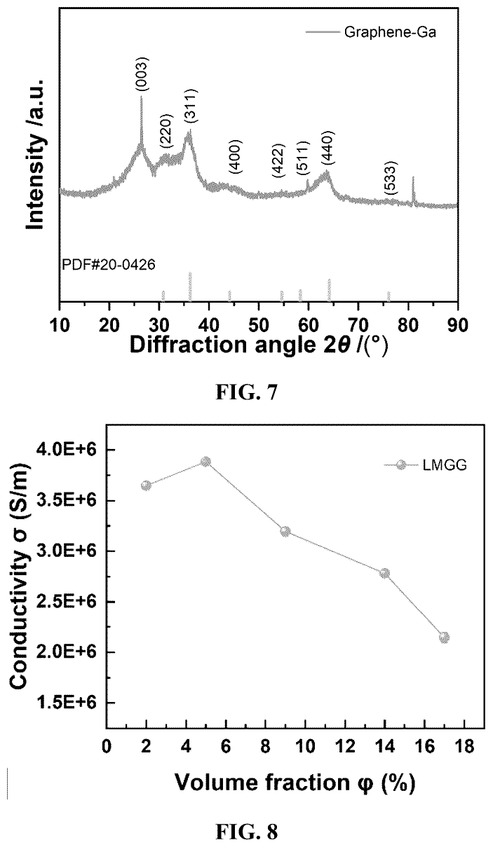

The microscopic morphology and elemental mapping of the gallium oxide-graphene composite material are described in FIGS. 6A-6F. As can be seen from FIGS. 6A and 6B, a layer of substance is attached to the surface of the graphene. Furthermore, the Energy Dispersive Spectroscopy (EDS) characterization in FIGS. 6C-6F confirms the presence of O and Ga elements in this substance. FIG. 7 shows the X-ray diffraction (XRD) pattern of the gallium oxide-graphene composite material. The analysis conducted using the X-ray diffractometer demonstrates that this substance is gallium oxide.

The flexible electrode material of this example comprises a mixture of 2 parts of the gallium oxide-graphene composite material and 98 parts of a liquid metal, by mass. The liquid metal is a gallium-indium alloy or a gallium-indium-tin alloy.

The flexible electrode of this example is fabricated as follows: the flexible electrode material is coated onto a flexible substrate via screen printing. Copper wires are attached to both ends of the printed flexible electrode material. A viscoelastic material coating is then applied over the surface of the flexible electrode material. The assembly is cured and dried at room temperature to obtain the flexible electrode.

The preparation method of the flexible electrode in this example is as follows:
Step A. Preparation of Liquid Metal Paste: A liquid metal paste, which is the flexible electrode material, was obtained by mixing 2 parts of the gallium oxide-graphene composite material with 98 parts of liquid metal.
Step B. Preparation of Flexible Electrode: The liquid metal paste was coated onto the surface of an Ecoflex 00-30 flexible substrate via screen printing, resulting in the flexible electrode.
Step C. Fabrication of Single Electrode: A copper wire with a diameter of 0.05 mm was attached to the end of the liquid metal paste. A silicone coating was then applied over the surface of the liquid metal paste. The assembly was dried at room temperature to obtain the encapsulated single electrode.

The electrical conductivity test results for the flexible electrode of this example are shown in FIG. 8. The measured electrical conductivity of the flexible electrode was 3.65×10⁶ S/m.

### Example 7

Different from that in Example 6, the preparation method of the gallium oxide-graphene composite material in this example employed 100 parts by mass of a 2M hydrochloric acid solution, 5 parts of graphene, 5 parts of gallium chloride, and 100 parts of ultrapure water.

The flexible electrode material of this example comprises a mixture of 5 parts of the gallium oxide-graphene composite material and 95 parts of liquid metal, by mass.

In Step A, the liquid metal paste was obtained by mixing 5 parts of the gallium oxide-graphene composite material with 95 parts of liquid metal.

The electrical conductivity test results for the flexible electrode of this example are shown in FIG. 8. The measured electrical conductivity of the flexible electrode was 3.89×10⁶ S/m.

### Example 8

Different from that in Example 6, the preparation method of the gallium oxide-graphene composite material in this example employed 100 parts by mass of a 2M hydrochloric acid solution, 9 parts of graphene, 9 parts of gallium chloride, and 100 parts of ultrapure water.

The flexible electrode material of this example comprises a mixture of 9 parts of the gallium oxide-graphene composite material and 91 parts of liquid metal, by mass.

In Step A, the liquid metal paste was obtained by mixing 9 parts of the gallium oxide-graphene composite material with 91 parts of liquid metal.

The electrical conductivity test results for the flexible electrode of this example are shown in FIG. 8. The measured electrical conductivity of the flexible electrode was 3.20×10⁶ S/m.

### Example 9

Different from that in Example 6, the preparation method of the gallium oxide-graphene composite material in this example employed 100 parts by mass of a 2M hydrochloric acid solution, 14 parts of graphene, 14 parts of gallium chloride, and 100 parts of ultrapure water.

The flexible electrode material of this example comprises a mixture of 14 parts of the gallium oxide-graphene composite material and 86 parts of liquid metal, by mass.

In Step A, the liquid metal paste was obtained by mixing 14 parts of the gallium oxide-graphene composite material with 86 parts of liquid metal.

The electrical conductivity test results for the flexible electrode of this example are shown in FIG. 8. The measured electrical conductivity of the flexible electrode was 2.78×10⁶ S/m.

### Example 10

Different from that in Example 6, the preparation method of the gallium oxide-graphene composite material in this example employed 100 parts by mass of a 2M hydrochloric acid solution, 17 parts of graphene, 17 parts of gallium chloride, and 100 parts of ultrapure water.

The flexible electrode material of this example comprises a mixture of 17 parts of the gallium oxide-graphene composite material and 83 parts of liquid metal, by mass.

In Step A, the liquid metal paste was obtained by mixing 17 parts of the gallium oxide-graphene composite material with 83 parts of liquid metal.

The electrical conductivity test results for the flexible electrode of this example are shown in FIG. 8. The measured electrical conductivity of the flexible electrode was 2.15×10⁶ S/m.

### Comparison Example 1

To explore the application potential of the aforementioned flexible electrodes, the flexible electrode from Example 3 was employed as an electronic skin (E-skin) for monitoring human joint motion. A series circuit was formed using metal wires and an LCR digital bridge tester. This E-skin was then attached to various joint areas, and the resistance changes of the flexible large-strain sensor in response to joint movements were recorded.

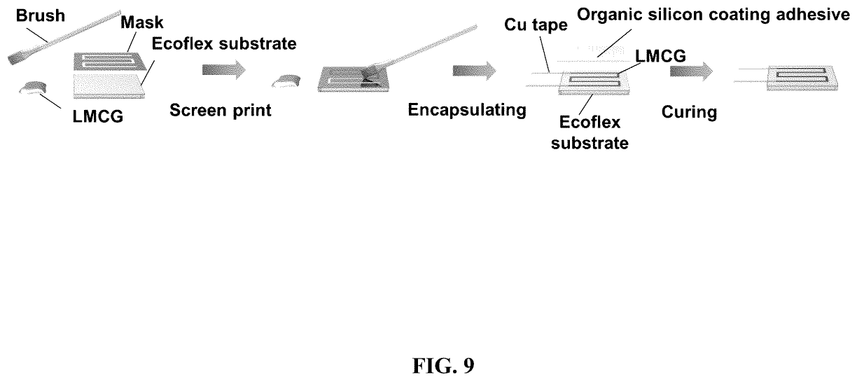

The fabrication process of the E-skin is illustrated in FIG. 9. The liquid metal paste (i.e., the flexible electrode material), obtained by mixing the gallium oxide-carbon nanotube composite material with liquid metal, was coated onto an Ecoflex 00-30 substrate via screen printing. Copper wires with a diameter of 0.05 mm were attached to the ends of the paste. A silicone coating was applied over the surface of the liquid metal paste to protect it from external interference. After curing and drying the flexible electrode material at room temperature, the resulting E-skin had dimensions of 60 mm in length, 45 mm in width, and 5 mm in height.

The functionality of the E-skin as a strain sensor was validated by attaching the prepared E-skin to various joint areas and monitoring the strain signals generated during human motion. Metal wires were fixed to both ends of the flexible electrode. The E-skin was capable of monitoring movements of body parts including the finger, wrist, elbow, and knee. The E-skin was fixed onto the body parts by adhering its ends with tape, enabling the detection of strain information from the bending of these joints.

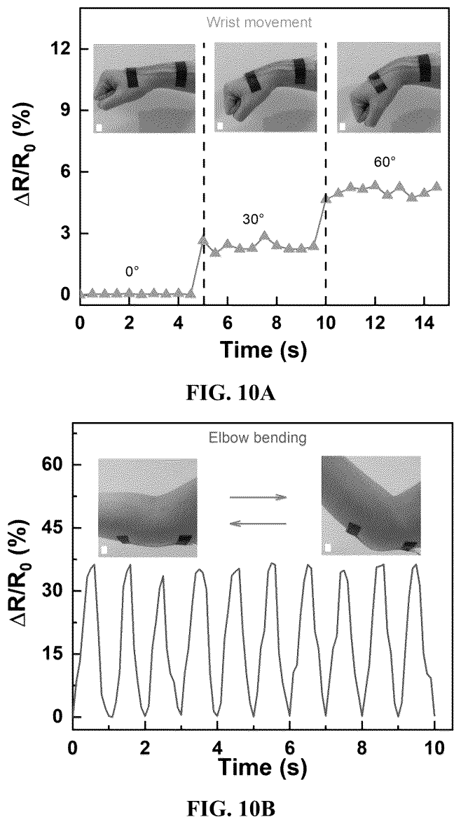

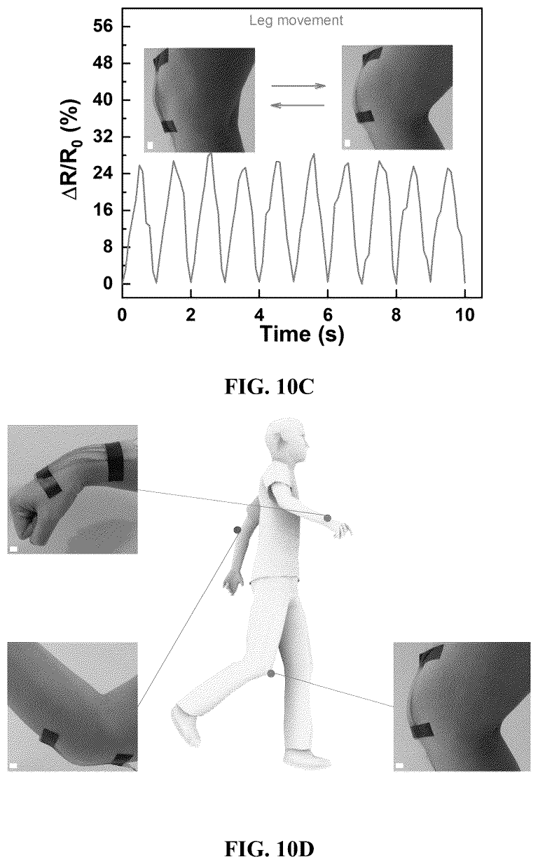

As shown in FIGS. 10A-10D, the E-skin generated corresponding and repeatable signals during the movement of these joints. In FIG. 10A, as the bending angle of the subject's wrist increased, the Relative Resistance Change (RRC) of the E-skin correspondingly increased. The RRC remained stable at a fixed bending angle. In FIGS. 10B and 10C, when the subject's elbow and knee joints were bent, the RRC from the E-skin increased correspondingly with the changes in the electrode's length and cross-sectional area. Upon extending the lower leg, the E-skin rapidly returned its output to the original state. When the knee joint was fully bent again, the E-skin accurately and rapidly detected the signals from the repeated motion. These tests demonstrate that the E-skin can be effectively used for detecting motion signals from human joints.

### Comparison Example 2

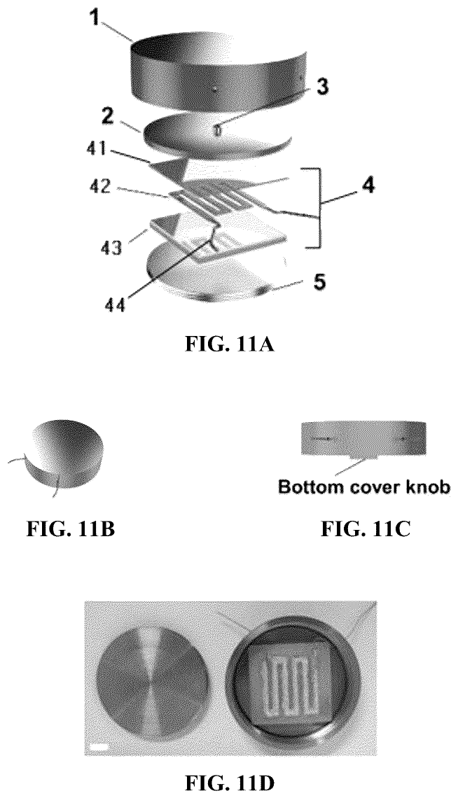

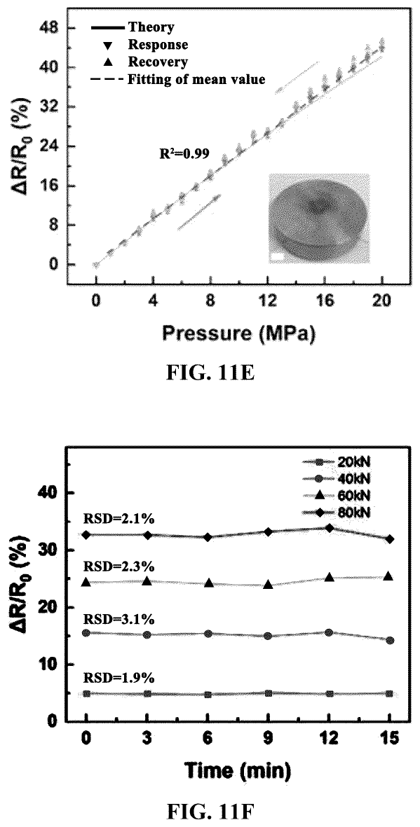

The flexible electrode from Example 7 was used to fabricate an earth pressure cell (earth pressure sensor) for monitoring soil pressure in geotechnical engineering. As shown in FIGS. 11A to 11D, the earth pressure cell comprises a cylindrical housing 1, and a connection cylinder 3, a spacer 2, the flexible electrode 4, and a bottom cover 5 sequentially arranged from top to bottom within the cavity of the cylindrical housing 1. The connection cylinder 3 is located centrally between the inner bottom surface of the cylindrical housing 1 and the spacer 2. The spacer 2, the flexible electrode 4, and the bottom cover 5 are in surface contact with each other. A conductive lead 44 of the flexible electrode 4 extends outwardly from the cavity of the cylindrical housing 1.

The stainless steel housing 1 has dimensions of a sidewall thickness of 5 mm, a top thickness of 1 mm, a height of 20 mm, and an inner diameter of 70 mm. The stainless steel spacer 2, which bears deflection, has dimensions of a thickness of 3 mm and an outer diameter of 69.6 mm. The connection cylinder 3 acts as a central load point for the spacer and has dimensions of a height of 4 mm and a diameter of 4 mm. The flexible electrode 4, serving as the sensing element, has dimensions of 49 mm in length, 49 mm in width, and 5 mm in height. The stainless steel bottom cover 5 has dimensions of a thickness of 5 mm and an outer diameter of 70 mm.

The flexible electrode 4 uses a paste composed of the graphene composite material mixed with liquid metal as the flexible electrode material. This material is printed to form a flexible trace 42 with a length of 231 mm, a width of 3 mm, and a height of 1 mm. The bottom surface of the flexible trace 42 is a soft substrate 43. A silicone layer 41 is coated over the top surface of the flexible trace 42. Conductive leads 44 are attached to both ends of the flexible trace 42.

The bottom cover 5 features protruding lugs, allowing it to be twisted and screwed into the housing. The periphery of the bottom cover is threaded, and the inner side of the earth pressure cell housing is equipped with a threaded sleeve, enabling the bottom cover to be screwed on to secure and make contact with the flexible electrode 4.

The sidewall thickness of the stainless steel housing is set to 5 mm to ensure the sensor sidewall is unaffected by lateral earth pressure. Operating Principle of the Earth Pressure Cell: Earth pressure applied to the top surface of the stainless steel housing is transmitted through the connection cylinder 3 to the stainless steel spacer 2, causing displacement of the spacer. This displacement is then transferred to the sensing element 4, fabricated from the flexible electrode. The internal flexible trace 44 of the sensing element is compressed, resulting in a change in its electrical resistance. The Relative Resistance Change (RRC) of the sensing element made from the flexible electrode, under applied external pressure, is shown in FIG. 11E, comparing theoretical predictions (solid green line) with experimentally measured values (triangles and inverted triangles). The RRC increases linearly with the applied pressure. The fitted average curve (blue dashed line) shows a high degree of similarity with the theoretical prediction. The error bars represent the standard deviation of the RRC from five measurements per sample, indicating significant repeatability and low hysteresis of the sensing element.

The RRC measured under different pressure levels is shown in FIG. 11F. Each loading cycle was maintained for 15 minutes, with readings recorded every 3 minutes. The maximum relative standard deviation (RSD=3.1%) of the test results demonstrates the high mechanical durability of the earth pressure cell.

It will be obvious to those skilled in the art that changes and modifications may be made, and therefore, the aim in the appended claims is to cover all such changes and modifications.

What is claimed is:

1. A method for preparing a carbon microparticle composite material, comprising:
1) purifying carbon microparticles by: i) contacting the carbon microparticles with an acidic solution to form a mixture; ii) heating the mixture using an oil bath under reflux conditions to obtain purified carbon microparticles, wherein the purified carbon microparticles have reduced impurity content and are dispersed, and the carbon microparticles are selected from the group consisting of multi-walled carbon nanotubes (MWCNTs) and graphene; and
2) compositing gallium oxide on surfaces of the purified carbon microparticles by: i) combining the purified carbon microparticles with gallium chloride in ultrapure water to form a reaction precursor; ii) transferring the reaction precursor to a reaction autoclave for a hydrothermal reaction to obtain a gallium oxide-carbon microparticle composite; and iii) calcining the gallium oxide-carbon microparticle composite in a tube furnace under a nitrogen atmosphere to yield a gallium oxide-carbon microparticle composite material with increased crystallinity.

2. The method of claim 1, wherein the acidic solution in 1) is nitric acid or hydrochloric acid having a concentration of H from about 1M to about 3M.

3. A flexible electrode material, comprising a mixture of 2-17 parts by mass of a gallium oxide-carbon nanotube composite material and 83-98 parts by mass of a liquid metal, wherein the gallium oxide-carbon nanotube composite material comprises carbon microparticles and gallium oxide attached to surfaces of the carbon microparticles; the carbon microparticles are carbon nanotubes or graphene, and the liquid metal is a gallium-indium alloy or a gallium-indium-tin alloy.

4. A method for preparing a flexible electrode, comprising: coating the flexible electrode material of claim 3 onto a flexible substrate via screen printing, attaching conductive wires to both ends of the flexible electrode material, applying a viscoelastic material coating over a surface of the flexible electrode material, and curing and drying the flexible electrode material at room temperature to obtain the flexible electrode.

5. An earth pressure cell, comprising:
a cylindrical housing comprising a cavity; and
a connection cylinder, a spacer, a flexible electrode prepared by the method of claim 4, and a bottom cover, which are disposed in sequence from top to bottom within the cavity of the cylindrical housing;
wherein:
the connection cylinder is disposed at a central portion between an inner bottom surface of the cylindrical housing and the spacer;
the spacer, the flexible electrode, and the bottom cover are in surface contact with each other; and
a conductive lead of the flexible electrode extends outwardly from the cavity of the cylindrical housing.
